(19) United States
(12) Patent Application Publication
(10) Pub. No.: US 2007/0044625 A1
(43) Pub. Date: Mar. 1, 2007

(54) Product table for a food slicer with hollow peripheral reinforcements

(76) Inventors: Scott J. Rote, New Lenox, IL (US); Michael R. Riechers, Grant Park, IL (US); Aaron B. Eiger, Chicago, IL (US); Frank Bondarowicz, Glenview, IL (US)

Correspondence Address: Mark W. Croll;Illinois Tool Works Inc., 3600 West Lake Avenue, Glenview, IL, 60026, US

(21) Appl. No.: 11/349,415

(22) Filed: Feb. 7, 2006

Related U.S. Application Data
(60) Provisional application No. 60/711,782, filed on Aug. 26, 2005.

(51) Int. Cl. B26D 7/06

(52) U.S. Cl. 83/703; 83/932

(57) ABSTRACT

A food slicer is provided having a support member including a base portion and an upstanding portion integrally formed with the base portion. The upstanding portion includes a rotating cutting blade secured thereto for slicing food product and at least one motor positioned within the upstanding portion for rotating the cutting blade. An adjustable gage plate also is provided for determining the thickness of a food product to be sliced by the cutting blade. The base portion includes a food product table slidably secured thereto and is movable across the cutting blade for holding product while it is being sliced by the cutting blade. The food product table has at least one peripheral reinforcement along an edge thereof where the reinforcement has a hollow channel therein.

### CROSS-REFERENCE TO RELATED APPLICATIONS

This application claims benefit of U.S. provisional patent application Ser. No. 60/711,782, filed Aug. 26, 2005, which is herein incorporated by reference.

### TECHNICAL FIELD

The present invention relates generally to food slicers and more particularly to a new design for a food slicer table that is of a reduced weight while having the needed rigidity that, when utilized with a new overall food slicer design, provides an improved sanitary environment, enables easier operation and cleaning and incorporates a number of enhanced ergonomic features.

### BACKGROUND

The basic design of both manual and automatic food slicers has proven to be quite effective and durable throughout the years. Although various important improvements have been made to such slicers, the overall design has not changed very much particularly with regard to the overall cleanliness, ergonomics, or ease of operation.

Today, food slicers are utilized to slice a number of food products such as meats, cheeses and the like in a variety of environments such as delicatessens, supermarkets, and restaurants to name a few. Such food slicers need to be quite durable since they tend to be used for many hours during a day by many different individuals while providing the desired performance, safety and cleanliness.

Additionally, food slicers need to be quite accommodating since they need to handle a variety of products of different shapes and sizes while readily providing different thicknesses of the product being sliced. The speed at which a particular product is moved across the cutting blade also varies on automatic food slicers to improve productivity.

Since food product tables of food slicers move back and forth across the cutting blade, they typically are made from metal, such as aluminum or stainless steel, to decrease the weight. Although some food product tables have been formed from plastic, they typically do not have the rigidity needed to handle a variety of products over years of extended use.

### SUMMARY

In accordance with an embodiment, a food slicer is provided having a support member including a base portion and an upstanding portion integrally formed with the base portion. The upstanding portion includes a rotating cutting blade secured thereto for slicing food product and at least one motor positioned within the upstanding portion for rotating the cutting blade.

An adjustable gage plate also is provided for determining the thickness of a food product to be sliced by the cutting blade.

The base portion includes a food product table slidably secured thereto and is movable across the cutting blade for holding product while it is being sliced by the cutting blade. The food product table includes at least one peripheral reinforcement along an edge thereof where the reinforcement has a hollow channel therein.

### BRIEF DESCRIPTION OF THE DRAWINGS

The present disclosure will become better understood with reference to the following description and accompanying drawings, wherein:

FIG. 1 is a top right perspective view of a food slicer according to one embodiment of the present invention;

FIG. 2 is a bottom perspective view of one embodiment of a food product table of FIG. 1;

FIG. 3 is a bottom perspective view of the food product table of FIG. 2 taken at a slightly different angle;

FIG. 4 is a bottom perspective view of the food product table of FIG. 2 taken at a slightly different angle; and

FIG. 5 is a cross-sectional view of the food product table taken along lines 5-5 of FIG. 4.

### DETAILED DESCRIPTION

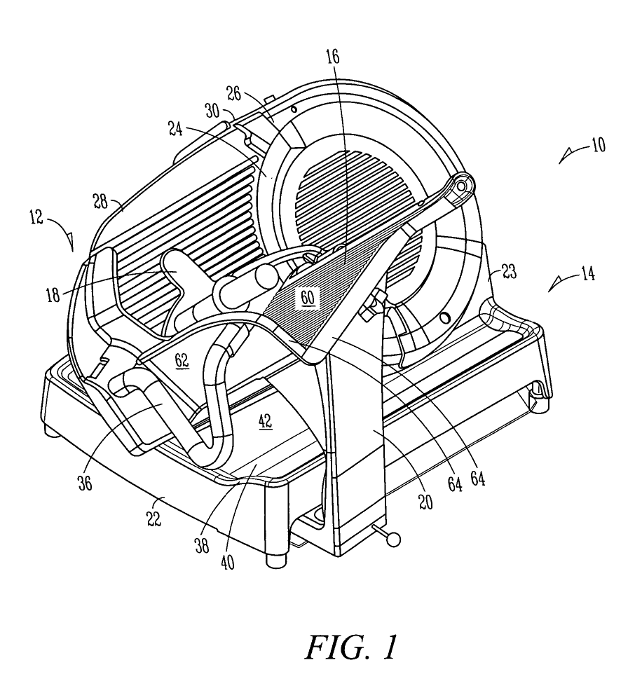

The food slicer of the present invention is generally illustrated by numeral 10 of FIG. 1 wherein like parts are designated by like reference numerals. Although the present disclosure will be described with reference to the example embodiments illustrated in the figures, it should be understood that the food slicer 10 may have many alternative forms without departing from the teachings of the present invention. One of ordinary skill in the art will additionally appreciate different ways to alter the parameters of the embodiments disclosed, such as the size, shape, or type of elements or materials, in a manner that falls within the spirit and scope of the present disclosure and appended claims.

FIG. 1 illustrates the basic components of the food slicer 10 of the present invention. The food slicer 10 substantially includes a food handling portion generally illustrated by reference numeral 12 and a support portion, housing or member generally illustrated by reference numeral 14.

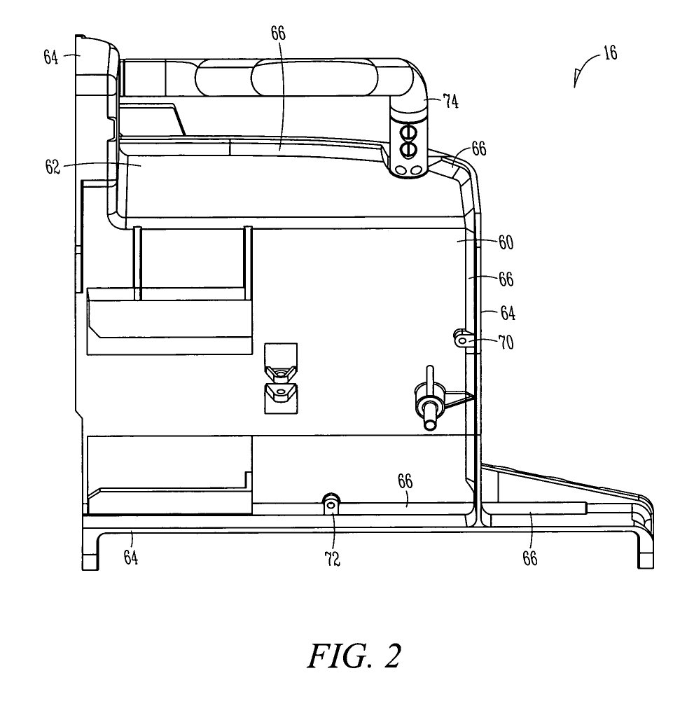

The food handling portion 12 substantially includes a product table 16, a push arm or pusher 18 and a product table support arm 20. The support portion 14 substantially includes a base portion or member 22, an upstanding portion or member 23, a rotating circular slicing knife or cutting blade 24, a ring guard 25, a knife cover 26, an adjustable gage plate 28 for determining slicing thickness and a control member or operator interface 30 having a gage plate support and adjustment mechanism 32 for the gage plate 28 and control buttons 34 as illustrated in FIG. 2.

The support portion 14 also includes at least one motor (not illustrated) positioned within the inside of the upstanding portion 23. If desired, a second motor (not illustrated) may be positioned within the inside of the support portion 14 along with associated structure for automatically moving the product table 16.

Briefly, for manual slicing, a food product (not illustrated) is placed on the product table 16 beneath the pusher 18 with the end to be cut or sliced resting upon the gage plate 28 with the product table 16 in its forward position. The operator adjusts the gage plate adjustment mechanism 32 which directly moves the gage plate 28 with respect to the blade 24 to provide a slice thickness gap therebetween that corresponds to the desired thickness for slicing of the product and gets bigger with thicker slices. The control buttons 34 are then accessed to turn the motor on which in turn rotates the blade 24.

The operator then pushes the product table 16 via a handle 36 forward or to the right with respect to FIG. 1 whereby the blade 24 slices the product to the desired thickness. The operator then pulls the product table 16 backward or to the left with respect to FIG. 1 for continued slicing of the product as described above.

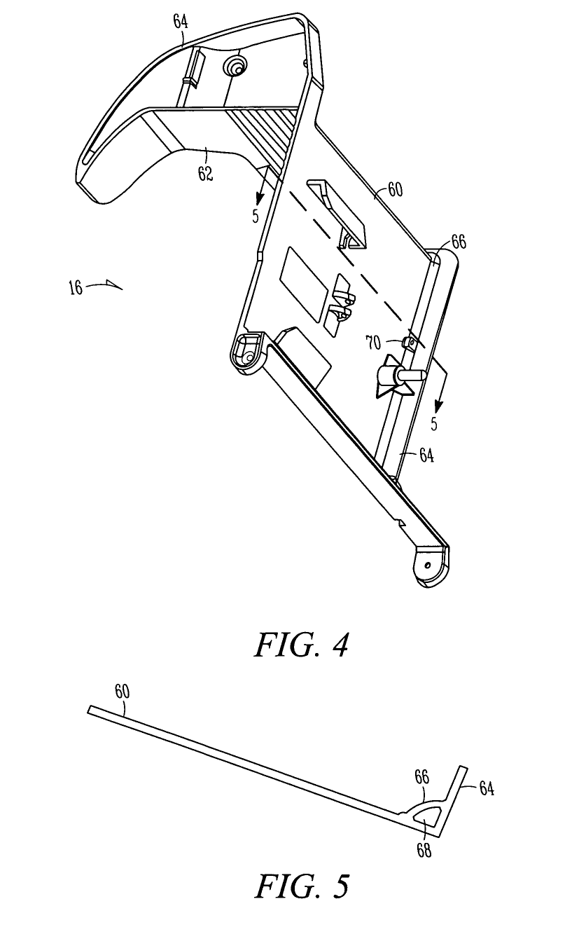

As FIGS. 1-4 generally illustrate, product table 16 may be constructed to have a bottom portion 60 upon which the food product to be sliced may sit, and a side portion 62 for the food product to rest against while being sliced. The particular design of the product table 16 can vary so long as it functions to hold the food product during slicing as desired.

In order to provide for enhanced rigidity of the product table 16, a lip 64 is included along one or more edges of the bottom portion 60 and/or the side portion 62. To further enhance the rigidity of the product table 16, one or more reinforcements 66 are provided between the bottom portion 60 and the lip 64 and the side portion 62 on a bottom side of the product table 16.

As FIG. 5 illustrates, the reinforcements 66 include a hollow channel 68 that extends longitudinally through the length of each reinforcement 66. The reinforcements 66 are closed at their ends and, for ease of molding, typically do not cross each other.

The reinforcements 66 and associated hollow channels 68 preferable are integrally formed with the bottom portion 60 and lip 64 or side portion 62 during molding. To form the hollow channels 68, a gas-assist injection molding process preferably is used where a gas, typically nitrogen, is injected into the material during molding, at one or more desired locations such as at points 70 and 72, at a specific temperature and pressure at a desired point in time during the molding process.

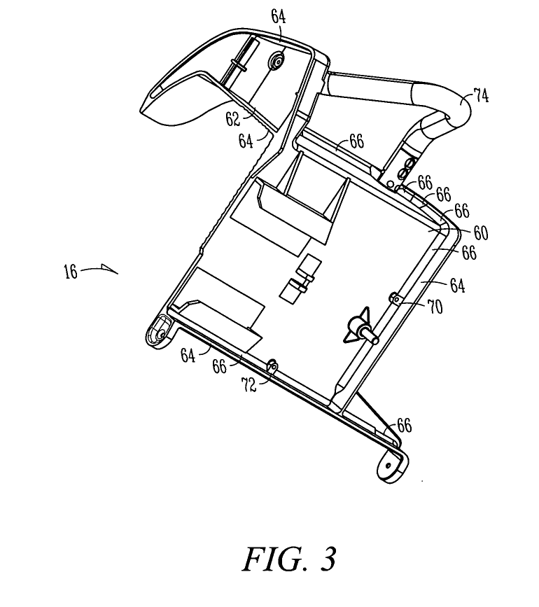

In this embodiment, gas injected at molding point 72 forms a continuous hollow channel 68 in the reinforcement 66 that runs along the bottom of the product table 16 illustrated in FIGS. 2 and 3 including beneath the lip 64 on the right side of the product table 16. Similarly, gas injected at molding point 70 forms a continuous hollow channel 68 in the reinforcement 66 that runs along the right and top side of the product table 16 including beneath a handle 74. It is to be understood, however, that the specific design, material, shape and method of molding the reinforcements 66 and hollow channels 68, as well as the way they are attached to the bottom portion 60 and lip 64 and the number and placement of the gas injection points 70 and 72, can vary.

The product table 16 preferably is formed from plastic to decrease weight since the product table 16 is a moving component of the slicer 10 and is removable for cleaning. To further enhance the rigidity of the product table 16, the product table 16 can be formed to include additional strengthening members, such as solid ribs or channels, or a strengthening material or additive, such as glass or the like. In practice, using 30% glass filled nylon provides the desired rigidity but it is to be understood that the particular material used to form the product table 16 as well as they type and amount of any strengthener or additive or strengthening member can vary.

Numerous modifications and alternative embodiments of the present disclosure will be apparent to those skilled in the art in view of the foregoing description. Accordingly, this description is to be construed as illustrative only and is for the purpose of teaching those skilled in the art the best mode for carrying out the present disclosure. Details of the structure may vary substantially without departing from the spirit of the present disclosure, and exclusive use of all modifications that come within the scope of the appended claims is reserved. It is intended that the present disclosure be limited only to the extent required by the appended claims and the applicable rules of law.

What is claimed is:

1. A food slicer, comprising:
a support member having a base portion and an upstanding portion integrally formed with said base portion;
a rotating cutting blade secured to said upstanding portion for slicing food product;
at least one motor positioned within said upstanding portion for rotating said cutting blade;
an adjustable gage plate for determining the thickness of a food product to be sliced by said cutting blade; and
a food product table slidably secured to said base portion and movable across said cutting blade for holding product while being sliced by said cutting blade, said food product table having at least one peripheral reinforcement along an edge thereof, said reinforcement having a hollow channel therein.

2. The food slicer as defined in claim 1, wherein said food product table is molded.

3. The food slicer as defined in claim 2, wherein said food product table includes at least one of a strengthening material or member.

4. The food slicer as defined in claim 3, wherein said strengthening material of said food product table is glass filled nylon.

5. The food slicer as defined in claim 1, wherein said food product table includes at least a bottom portion and a side portion and said reinforcements are positioned therebetween.

6. A product table for a food slicer comprising:
a first member; and
at least one peripheral reinforcement for stiffening said first member of the product table, said reinforcement having a hollow channel therein.

7. The product table as defined in claim 6, wherein said first member and said peripheral reinforcement are integrally formed.

8. The product table as defined in claim 6 wherein said first member and said peripheral reinforcement are molded.

8. The product table as defined in claim 6, wherein at least said first member includes at least one of a strengthening material or member.

9. The product table as defined in claim 8, wherein said strengthening material of said first member is glass filled nylon.

10. The product table as defined in claim 6, including a second member integrally formed as a lip about at least one edge of said first member, said at least one peripheral reinforcement being integrally formed along the intersection of said lip and said first member.
